(19) United States
(12) Patent Application Publication
(10) Pub. No.: US 2007/0224015 A1
(43) Pub. Date: Sep. 27, 2007

(54) Fastening element

(75) Inventor: Thomas Ayrle, Langerringen (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/726,757

(22) Filed: Mar. 21, 2007

(30) Foreign Application Priority Data
Mar. 22, 2006 (DE) 10 2006 000 128.1

(51) Int. Cl. F16B 13/06

(52) U.S. Cl. 411/55

(57) ABSTRACT

A fastening element for constructional components, includes an anchor bolt and an expansion sleeve (18, 38), with the anchor bolt having a load application element (15) at its first end region (14) of the anchor stem (13, 33), and at a second, opposite end region (16, 36) an expansion portion (17, 37) having a conical section (19, 39) that expands in a direction of a free end of the second end region, and a cylindrical section (20, 40) that adjoins the conical section (19, 39) and has a shaped profile formed by ribs (26, 46) extending parallel to the longitudinal axis (12, 32) of the stem with the ribs (26, 46), projecting beyond an axial projection of an outer profile of the expansion sleeve (18, 38) by a distance (U. V).

### BACKGROUND OF THE INVENTION

1. Field of the Invention

The present invention relates to a fastening element for being anchored in a borehole of a constructional component and including an anchor bolt and an expansion sleeve. The anchor bolt has a stem having a longitudinal axis and provided with load application means at its first end region and at its second, opposite end region with an expansion portion for expanding the expansion sleeve that at least partially surrounds the stem. The expansion portion has a conical section that expands in a direction of a free end of the second end region of the stem, and a cylindrical section that adjoins the conical section and has a shaped profile.

2. Description of the Prior Art

Fastening elements of the type described above serve for attachment of objects to a constructional component that has a borehole for receiving the fastening element. The fastening element becomes anchored as a result of a relative displacement between the expansion portion of the anchor bolt stem and the expansion sleeve. The expansion portion expands the expandable expansion sleeve radially upon tightening of the fastening element and, thereby, the fastening element becomes clamped in the borehole. For mounting the fastening element through a through-opening, which is formed in an object which is to be attached to a constructional component, the fastening element has, in its untighted condition, a substantially same radial extent over its entire longitudinal extent.

The more the fastening element is loaded, the greater is the expansion force, and the farther the expansion portion is pulled into the expansion sleeve. The maximal load applicable to the fastening element depends, on one hand, on the bearing capacity of the material used for producing the fastening element and, on the other hand, on the bearing capacity of the constructional component. The applied tightening force can be controlled by using a torque wrench.

European Publication EP 1 243 801 A1 discloses, e.g., a fastening element to be anchored in a borehole of a constructional component and having an anchor bolt and an expansion sleeve. The anchor bolt has a stem having a longitudinal axis and provided with load application means at its first end region and at its second, opposite end region with an expansion portion for expanding the expansion sleeve that at least partially surrounds the stem, with the expansion portion having a conical section that expands in a direction of a free end of the second end region of the stem, and a cylindrical section that adjoins the conical section. To prevent the expansion sleeve from rotation relative to the expansion portion, there is provided, on the conical section of the expansion portion, a plurality of ribs extending parallel to the longitudinal axis of the stem and projecting radially from the expansion portion and which engage in the longitudinal slots of the expansion sleeve.

The drawback of the known solution consists in that many users do not use a torque wrench when tightening such fastening elements, and a high load can be applied to the fastening element. This can lead to penetration of the expansion portion through the expansion sleeve and, thus, to a failure of the fastening element. Further, because of a high expansion force imparted to a constructional component, the constructional component can crack in some regions.

This increases the anchoring region that also can lead to a failure of the fastening element. In particular, with small fastening elements set in relatively large boreholes, upon tightening of the fastening element, there occur problems resulting from rotation of the fastening element.

German utility Model D1 71 00 768 U discloses another fastening element of the type descried above in which in order to prevent penetration of the expansion portion through the expansion sleeve, the cylindrical section of the expansion portion is provided with a shaped profile in form of flutes extending in the longitudinal direction of the fastening element.

The drawback of the fastening element of the German Utility model consists in that upon tightening of the fastening element, it still can rotate in the borehole.

Accordingly, an object of the present invention is a fastening element for being anchored in borehole of a constructional component and having a reduced tendency of the expansion portion penetrating through the expansion sleeve.

Another object of the present invention is a fastening element of the type discussed with which its rotation in a borehole of a constructional component is prevented.

A further object of the present invention is a fastening element of the above-described type that can be set in a borehole of a constructional component in a simple way.

### SUMMARY OF THE INVENTION

These and other objects of the present invention, which will become apparent hereinafter, are achieved by providing a fastening element of a type described above in which the shaped profile of the cylindrical section of the expansion portion is formed by ribs provided on the cylindrical section and extending parallel to the longitudinal axis, the ribs projecting beyond an axial projection of an outer profile of the expansion sleeve by a distance. With separate ribs being provided on the cylindrical section of the expansion portion, the maximal diameter of the expansion portion is pointwise increased, which influences the settability of the fastening element only slightly. The produced gap between the expansion portion and the borehole wall is filled, e.g., with produced drillings and drilling dust.

The projection of the ribs beyond the axial projection of the outer profile of the expansion sleeve over the circumference of the expansion sleeve is advantageously so selected that during driving of the fastening element in the borehole, the ribs furrow the borehole wall. The produced force-and formlocking connection of the expansion portion with the borehole wall prevents rotation of the fastening element in the borehole and facilitate centering of the expansion portion and, thereby, of the entire fastening element in the borehole. The prevention of rotation of the fastening element, which is obtained with the ribs, also reduces the tendency of the fastening element to rotate when a heavy-duty thread is used as the load application means, which is often the case under constructional site conditions.

In addition, the ribs, which are provided on the cylindrical section of the expansion portion and extend in the longitudinal direction, form an additional resistance for the expansion sleeve, which prevents pulling of the fastening element through. Therefore, the inventive fastening element is characterized by higher failure loads than a conventional fastening element and has a smaller variance of holding values.

Advantageously, the distance by which the ribs project beyond axial projection of an outer profile of the expansion sleeve amounts to from 3 to 2 mm.

Thereby, with a conventional ratio between the outer diameter of the fastening element and the inner diameter of the borehole wall, a contact of the ribs with the borehole wall during setting of the fastening element in the borehole and, thereby, a furrow effect of the ribs is insured.

Advantageously, from two to eight ribs are provided on the cylindrical section of the expansion portion. Preferably, four ribs are provided on the cylindrical section, whereby an advantageous relationship between high resistance during setting of the fastening element and increase of load, which is achieved with ribs, is obtained.

Advantageously, the ribs are uniformly distributed over a radial circumference of the cylindrical section of the expansion portion. Thereby advantageous auxiliary means for centering the fastening element during setting is provided.

Advantageously, the ribs have, in a direction transverse to the longitudinal direction of the fastening element, a roof-shaped profile. This facilitates formation of furrows in the borehole wall.

Advantageously, the angle of the roof-shaped profile is less than 120°, which further facilitates formation of furrows in the borehole wall. It is particularly advantageous when the angle of the roof-shaped profile is less than 60°.

Advantageously, the ribs have a first edge extending parallel to the longitudinal axis and forming an extension of an angle of the expansion portion. This insures a continuous transition from the conical section of the expansion portion to the ribs during expansion of the sleeve, and a better introduction of the resulting expansion force into the constructional component. Alternatively, the edge of the ribs can have an angle relative to the longitudinal axis which is different from such an angle of the conical section and is greater than the angle of the conical section.

Advantageously, the ribs have a second edge extending parallel to the longitudinal axis and formed as a sharp cutting edge. This facilitates even further formation of furrows in the borehole wall during setting of the fastening element.

Advantageously, the second edge extends to the free end of the expansion section. This facilitates formation of furrows in the borehole wall particularly during setting of the fastening element.

Alternatively, the second edge extends parallel to the longitudinal axis of the fastening element, and a third edge adjacent to the free end of the fastening element extends transverse to the longitudinal axis. The third edge is also advantageously formed as a sharp cutting edge. In order to facilitate the setting of the fastening element, the corner between the second and third edges is advantageously chamfered. This embodiment of the ribs is easily formed, which enables an easy and cost-effective manufacturing of the inventive fastening element.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a longitudinal side view of a fastening element according to the present invention;

FIG. 2 a cross-sectional partial view of region A in FIG. 1 at an increased, in comparison with FIG. 1, scale;

FIG. 3 a cross-sectional view along line III-III in FIG. 1 at an increased, in comparison with FIG. 1, scale; and

FIG. 4 a view similar to that of FIG. 2 of another embodiment of a fastening element according to the present invention.

In the figures, the same elements are designated with the same reference numerals.

### DETAILED DESCRIPTION OF THE PREFERRED EMBODIMENTS

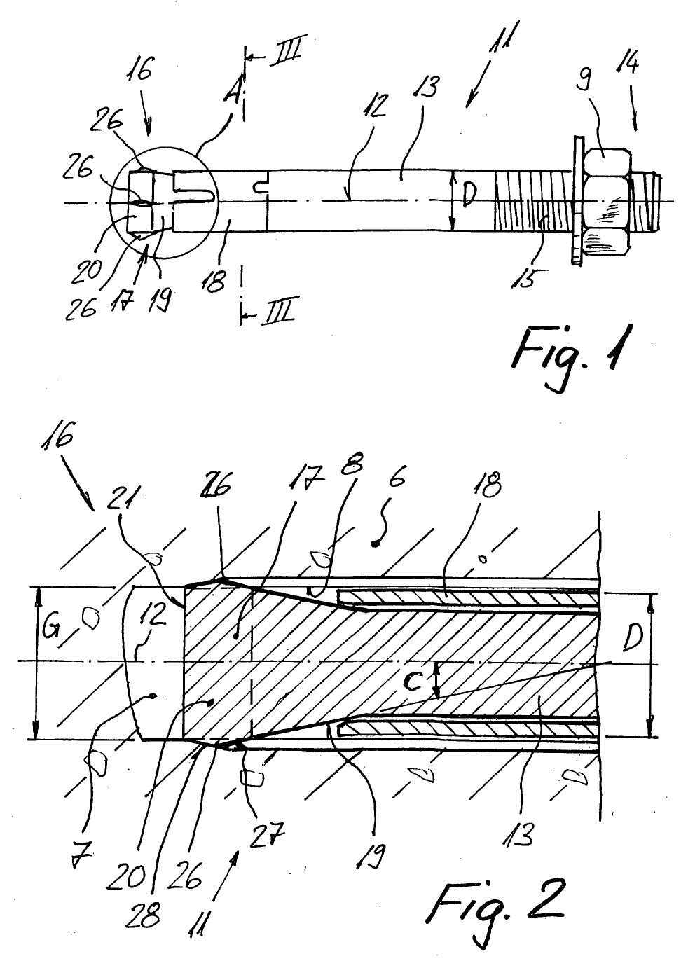

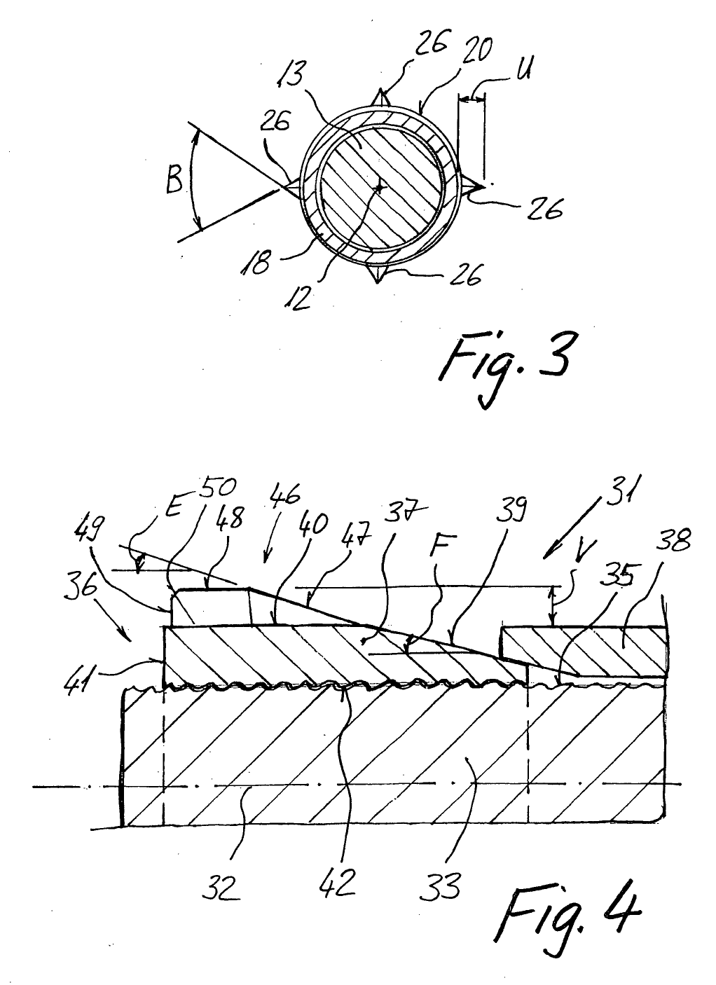

A fastening element 11 according to the present invention, a first embodiment of which is shown in FIGS. 1-3 and which is designed for being anchored in a borehole 7 of a constructional component 6, includes an anchor bolt and an expansion sleeve 18. The anchor bolt has a stem 13 having a longitudinal axis 12. The stem 13 has a first end region 14 at which there is provided load application means 15, and a second opposite end region 16 at which there is provided an expansion portion 17 for expanding the expansion sleeve 18 that at least partially surrounds the stem 13. The expansion portion (17) has a conical section 19 that expands toward the free end of the stem 13, and a cylindrical section 20 that adjoins the conical section 19 and has a certain profile. The conical section 19 is located adjacent to the expansion sleeve 18.

The profile on the cylindrical section 20 of the expansion portion 17 is formed by four ribs 26 extending parallel to the longitudinal axis 12 of the stem 13 and projecting radially from the expansion portion 17. The ribs 26 project beyond the axial projection of the outer profile of the expansion sleeve 18 by a distance U that amounts, in the embodiment shown in FIGS. 1-3, to 1.5 mm for all ribs 26. The ribs 26 are uniformly distributed over the radial circumference of the expansion portion 17.

Ribs 26 have, in a direction transverse to the longitudinal extent of the stem 13, a roof-shaped profile with the angle B of the roof-shaved profile amounting to 55°. The ribs 26 also have a roof-shaped profile in the longitudinal direction parallel to the longitudinal axis 12. A first edge 27 of the ribs 26, which extends parallel to the longitudinal axis 12, extends so that it forms an extension of the angle C of the conical section 19 of the expansion portion 17. In the embodiment shown in the drawings, the angle C amounts to 12°. A second edge 28, which also extends parallel to the longitudinal axis 12 and adjacent to the free end 21 of the expansion portion 17, is formed as a sharp cutting edge extending toward the free end 21.

For setting the fastening element 11, firstly, at a predetermined location, the borehole 7 is bored in the constructional component 6, and finally, the fastening element 11 is set in. The fastening element 11 has a diameter D that is somewhat smaller than the diameter G of the borehole 7. Because the ribs 26 are spaced from the axial projection of the outer profile of the expansion sleeve 18 by a distance U, the ribs 26 contact the wall 8 of the borehole 7 and furrow it, so that the expansion portion 17 frictionally and formlockingly is retained in the borehole 7. The expansion sleeve 18 has projections (not shown here) which bear against the borehole wall 8. Upon tightening the set fastening element 11 with the next 9, the expansion portion 17 is displaced axially relative to the expansion sleeve 18, expanding the same.

A second embodiment of a fastening element according to the present invention and which is designated with a reference numeral 31, is shown in FIG. 4. The fastening element 31 has a stem 33 which is formed as a threaded rod with an outer thread 35 that extends over an entire longitudinal extent of the stem 33 parallel to the longitudinal axis 32 of the stem 33. At the first end region of the stem 33, the outer thread 35 forms load application means at the second opposite end region 36 of the stem 33, there is provided a cone sleeve with an inner thread 42 and which forms an expansion portion 37 for expanding an expansion sleeve 38 which at least partially surrounds the stem 33. The cone sleeve with the inner thread 42 is screwed on the threaded rod that forms the stem 33. The expansion portion 37 has a conical section 39 that expands in the direction of the free-end of the second end region 36, and cylindrical section 40 that adjoins the conical section 39 and has a shaped profile.

The profile of the cylindrical section 40 of the expansion portion 37 is formed by ribs 46 expending parallel to the longitudinal axis 32 and projecting radially from the expansion portion 37. The ribs 46 project beyond the axial projection of the outer profile of the expansive sleeve 38 by a distance V that amounts, in the embodiment shown in FIG. 4, to 1 mm.

The ribs 46 have, in the direction transverse to the longitudinal direction of the stem 33, a roof-shaped profile. In the direction parallel to the longitudinal axis 32, the ribs 46 have a trapezoidal profile. A first edge 47 of ribs 46, which extends parallel to the longitudinal axis 32, extends at an angle E that amounts to 20° relative to the longitudinal axis 32. The angle F of the conical section 39 of the expansion portion 37 amounts, in the embodiment shown in FIG. 4, to 10° relative to the longitudinal axis, i.e., it is smaller than the angle E. The second edge 48 of the ribs 46 extends parallel to the longitudinal axis 32 and forms a sharp cutting edge. There is further provided a third edge 49 adjacent to the free end 41 of the expansion portion 37 and which extends transverse to the longitudinal axis 32. The third edge 49 is also formed, e.g., as a sharp cutting edge. The corner 50 between the second edge 48 and the third edge 49 is chamfered.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A fastening element for being anchored in a borehole (7) of a constructional component, comprising an anchor bolt; and an expansion sleeve (18, 38);
wherein the anchor bolt has a stem (13; 33) having a longitudinal axis (12, 32) and provided with load application means (15) at a first end region (14) thereof and at a second, opposite end region (16, 36) thereof, with an expansion portion (17, 37) for expanding the expansion sleeve (18, 38) that at least partially surrounds the stem (13, 33), the expansion portion (17, 37) having a conical section (19, 39) that expands in a direction of a free end of the second end region (16, 36) of the stem (13, 33), and a cylindrical section (20, 40) that adjoins the conical section (19, 39) and has a shaped profile formed by ribs (26, 46) provided on the cylindrical section (20, 40) and extending parallel to the longitudinal axis (12, 32), the ribs (26, 46) projecting beyond an axial projection of an outer profile of the expansion sleeve (18, 38) by a distance (U; V).

2. A fastening element according to claim 1, wherein the distance by which the ribs (26, 46) project beyond the axial projection of an outer profile of the expansion sleeve (18, 38) amounts to from 0.3 to 2 mm.

3. A fastening element according to claim 1, wherein a number of ribs (26, 46) formed on the cylindrical section (20, 40) of the expansion portion (17, 37), is from two to eight.

4. A fastening element according to claim 1, wherein the ribs (26, 46) are uniformly distributed over a radial circumference of the cylindrical section (20, 40) of the expansion portion (17, 37).

5. A fastening element according to claim 1, wherein the ribs (26, 46) have, in a direction transverse to the longitudinal direction, a roof-shaped profile.

6. A fastening element according to claim 5, wherein an angle (B) formed by the roof-shaped profile is less than 120°.

7. A fastening element according to claim 1, wherein the ribs (26, 46) have a first edge (27) extending parallel to the longitudinal axis (32) and forming an extension of an angle (c) of the expansion portion (17).

8. A fastening element according to claim 1, wherein the ribs (26, 46) have a second edge (28, 48) extending parallel to the longitudinal axis (12, 32) and formed as a sharp cutting edge.

9. A fastening element according to claim 8, wherein the second edge (28) extends to the free end (21) of the expansion portion.
